(19) United States
(12) Patent Application Publication
(10) Pub. No.: US 2021/0267223 A1
(43) Pub. Date: Sep. 2, 2021

(54) A SYSTEM AND METHOD FOR AUTOMATIC CALIBRATING, CUTTING AND GRADING NATURAL INTESTINES

(71) Applicants: Peter ANDERSEN, Taastrup (DK); Mikkel BOCK, Taastrup (DK); Birger FABRICIUS-OISEN, Taastrup (DK); Flemming CHRISTENSEN, Taastrup (DK); Teknologisk lnstitut, Taastrup (DK)

(72) Inventors: Peter Andersen, Taastrup (DK); Mikkel Bock, Taastrup (DK); Birger Fabricius-OIsen, Taastrup (DK); Flemming Haugaard Christensen, Taastrup (DK)

(21) Appl. No.: 17/254,382

(22) PCT Filed: Jun. 24, 2019
(86) PCT No.: PCT/EP2019/066633

§ 371 Date: Dec. 21, 2020

(30) Foreign Application Priority Data
Jun. 25, 2018 (DK) PA 2018 00292

(51) Int. Cl. A22C 17/14; A22C 13/00

(52) U.S. Cl. CPC A22C 17/14; A22C 13/0003

(57) ABSTRACT

The disclosure relates to a system and method for automatic sorting of natural intestines/casings for use in the production of food products, and especially as casings for sausages. A partly hollow feeding mandrel is configured to hold an intestine such that the intestine surrounds the feeding mandrel. The feeding mandrel includes a measuring area configured to transport water through a hollow part of the feeding mandrel through punctures in a surface of the measuring area, and into a cavity of the surrounding intestine. A vision device obtains images of the intestine, and a processor processes the images to sort the natural intestines or casings.

### CROSS-REFERENCE

The present application is the U.S. national stage entry under 35 U.S.C. § 371 of PCT Application PCT/EP2019/066633, filed 24 Jun. 2019, entitled “A SYSTEM AND METHOD FOR AUTOMATIC CALIBRATING, CUTTING AND GRADING NATURAL INTESTINES,” and claims the benefit of Danish Patent Application No. PA 2018 00292, filed 25 Jun. 2018, entitled “A SYSTEM AND METHOD FOR AUTOMATIC CALIBRATING, CUTTING AND GRADING NATURAL INTESTINES.” Each of these applications is incorporated herein by reference in its entirety.

### FIELD OF DISCLOSURE

The present disclosure relates to a system and method for automatic sorting of natural intestines/casings for use in the production of food products, and especially as casings for sausages.

### BACKGROUND

Casing, sausage casing, or sausage skin is the material that encloses the filling of a sausage. Casings may be divided into two categories, natural and artificial casings.

Natural intestines, obtained from e.g. domesticated animals, are intrinsically irregular in shape, and often, when viewed along its length, a natural intestine is seen to depart widely from the ideal shape of a geometric cylinder. Calibration of intestines, therefore, is usually performed manually, e.g. by filling water into the intestine, and then section-wise determining the calibre of the filled intestine. This is a very labour-intensive work, often associated with poor working positions, which also involves a long training of people to perform such calibration.

US 2004-423655 and US 2015-013881 both relate to methods for producing casings of longer length, which methods involve a device using heating and pressure to fuse together casing sections, and DE 19531831 relates to a method for treating natural intestines with ultrasound, thus fusing together casing sections.

U.S. Pat. No. 5,007,878 relates to a method for treating a natural casing, having an irregular shape, for obtaining a casing with a regular calibre, which method involves placing the intestine around a support with the desired calibre, and subjecting it to a microwave treatment.

WO 2014/016636 relates to a method for preparing a casing with a uniform calibre, which method comprises the subsequent steps of treating a natural casing with an aqueous acid solution, treating the casing with an alkaline solution, and drying the casing on a cylindrical support made of a flexible and inflatable material.

However, a system for semi-automatic or automatic calibrating and grading and/or cutting natural intestines/casings as disclosed herein has never been suggested.

### SUMMARY

The present disclosure is directed to a system for semi-automatic or automatic gauging, calibration, and/or grading of natural intestines/casings, which system makes is possible to identity and sort casing sections of uniform sizes. Moreover, the system according to this disclosure significantly reduces the extent of manual work previously associated with this procedure, allowing one operator to operator one or more machines simultaneously.

### BRIEF DESCRIPTION OF DRAWINGS

Examples of the principles of the present disclosure are illustrated in the drawings, of which:

FIG. 1 is a schematic illustration of a system for automatic calibrating, cutting and grading natural intestines;

FIG. 2 is a schematic illustration of a portion of a system for automatic calibrating, cutting and grading natural intestines;

FIG. 3 is a schematic illustration of a system for automatic calibrating, cutting and grading natural intestines;

FIGS. 4A, 4B, and 4C are diagrams of a transporting wheel;

FIG. 5 is a side view diagram of a machine stand including a system for automatic calibrating, cutting and grading natural intestines; and

FIG. 6 is a schematic illustration of a light and camera setting for use in a system for automatic calibrating, cutting and grading natural intestines.

### DETAILED DESCRIPTION

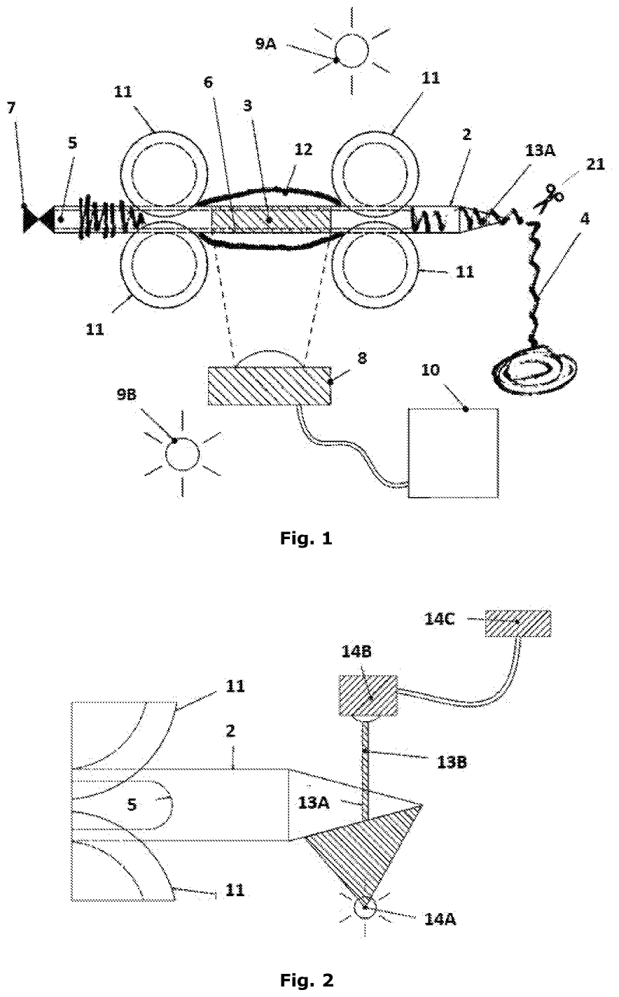

Referring to FIG. 1 in a first aspect, the present disclosure provides a system for semi-automatic or automatic gauging, calibrating, and/or grading natural intestines/casings. The system of the invention may include:

a partly hollow feeding mandrel (2), for holding an intestine (4) fed onto said feeding mandrel (2), such that said intestine (4) surrounds said feeding mandrel (2), and which feeding mandrel (2) comprises a measuring area (3), designed so that it can transport water through the hollow part (5) of the feeding mandrel (2) through punctures (6) in the surface of measuring area (3), and into the cavity (12) of the surrounding intestine (4), and which partly hollow feeding mandrel (5) is connected to a water supply (7);

a vision device (8), for obtaining at least one image of said intestine (4) while it is being fed onto said feeding mandrel (2);

one or more lights sources (9a, 9b), for illuminating said intestine (4) while is it located on said feeding mandrel (2);

a processor (10), for analysing and processing said image obtained by said vision device (8), to determine the pattern of the intestine, to calculate the length of the intestine (4), or part hereof, and to determine the calibre of said intestine (4), or part hereof, and/or to detect any perforations in said intestine (4);

a transporting device (11), capable of moving, in both directions, said intestine (4) along said feeding mandrel (2), and at the same time capable of building a water containing cavity (12) created by the surrounding intestine (4); and

a sensing device (14), for determining an end of said intestine (4), and in communication with the transporting device (11), for the transporting device (11) to stop transporting before the end of said intestine (4) has reached the measuring area (3).

The transporter (11) may include four or more wheels, each wheel conformed to follow the surface of the feeding mandrel (2), allowing the water cavity (12) to be built between the four or more wheels, and allowing for clear pictures to be taken by the camera (8).

The feeding mandrel (2) of the disclosure may be of any size and shape suitable for handling natural intestines, e.g. having a diameter of from about 10 to 50 mm, e.g. of from 15 to 30 mm, and having a length of from about 0.5 m to about 10 m, e.g. of from about 1 m to about 3 m.

The measuring area (3) of the feeding mandrel (2) of the disclosure is designed so that it can transport water through the hollow part (5) of the feeding mandrel (2), through holes (6) in the surface of measuring area (3). In one example, the length of the measuring area (3) is of from about 10 to about 50 cm, e.g. of from about 15 to about 40 cm.

There shall be a sufficient number of holes or perforations (6) in the measuring area (3) of feeding mandrel (2), and of a proper size, in order to fill the intestine (4) with water (7) reasonably quick, so as to keep up with the speed of the transporting device. The number of holes, and the size of these holes, greatly depends on the length of the measuring area (3). It is currently believed that any number of holes, e.g. of from 5 to 100, or of from 15-40, each hole having a diameter of about 2-8 mm, e.g. of from 2-6 mm, or around 4 mm, will satisfy this criterion, if the length of the measuring area is about 50 cm.

The holes (6) may be distributed throughout the measuring area in any pattern. In one example, the perforations (holes) constitute one or more straight lines running through the measuring area (3). In another example, the perforations (holes) in the measuring area constitute a straight line running through the upper part of the feeding mandrel.

In order to improve on the quality of the images to be taken at the measuring area, the surface of the measuring (3) area may be modified, e.g. by coating with various materials of any colours or textures. The surface may be glossy or non-glossy, and it may be black or grey or any other colour that gives a sufficient contrast the image obtained by the vision device. In one example, the feeding mandrel is coated with a matte black, smooth material, which may e.g. be Teflon.

To ensure a coverage in all directions, the vision device (8) of the system of the disclosure may comprise two or more cameras (8A, 8B, etc.), strategically positioned relative to each other, to the light sources (9A, 9B, etc), and to the measuring area (3), e.g. as outlined in FIG. 6. Moreover, to achieve a better contrast in the images obtained by the cameras, in particular for detecting water leaks, two of more light sources (9A, 9B, etc.), optionally of different colours, may be employed, e.g. a combination of white light (9A″, 9C″) and blue light (9b′, 9D′), as also outlined in FIG. 6.

The sensing device (14) may include a hole (13A) allowing the passage of light (14A) through the tip, as described in more detail in relation to FIG. 2.

Referring to FIG. 2, in one example, the system includes a sensing device (14), comprising a light source (14A), throwing (directional) light through a hole (13A) through the tip of the feeding mandrel (2), and which light hits a light sensor (14B) only when there is no intestine (4) surrounding the feeding mandrel (2). This design allows the system to establish the presence of an intestine on the feeding mandrel (2), and to determine the end of said intestine.

In another example, the light source (14A) is a light emitting diode (LED), throwing directional light through the hole (13A) through the tip of the feeding mandrel (2), to hits the light sensor (14B) when there is no intestine (4) surrounding the feeding mandrel (2).

In yet another example, a system (1) for semi-automatic or automatic gauging, calibrating, grading and/or cutting natural intestines, which system (see e.g. FIG. 2) may be characterised by further comprising a cutting device (21), for cutting the intestine (4) at a specific location identified by the processor as a transition point, at which transition point the calibre or grade of the intestine changes according to specifications, or which transition point marks the beginning of a stretch in the intestine containing one or more holes.

The cutting device (21) may comprise a knife, a scissor or a laser cutter, either manually operated, or automatically operated, in communication with the vision device (8), and in communication with the processor (10), and in cooperation with the transporting device (11).

According to the present disclosure, measuring of the length of the intestine (4) loaded onto the feeding mandrel (2), and later subjected to calibration, is accomplished using pattern recognition and digital image processing, and particularly feature extraction. Pattern recognition is a branch of machine learning that focuses on the recognition of patterns and regularities in data, in this case data obtained from the vision device (8). Feature extraction starts from an initial set of measured data, here images obtained by the camera comprised by the vision device (8). For a picture taken by the camera, a pattern of features is identified, and for each new picture taken by the camera, the pattern, or part of the pattern of features is recovered, and by calculating the number of pixels that the specific pattern has moved, and the time elapsed since last picture taken, the distance (converted from pixels to e.g. mm) and speed is calculated.

Several data analysis software packages provide for feature extraction. Common numerical programming environments such as MATLAB, SciLab, NumPy and “the R language” provide some of the simpler feature extraction techniques via built-in commands. More specific algorithms are publicly available as scripts or third-party add-ons. There are also software packages targeting specific software machine learning applications that specialize in feature extraction.

In order to create a suitable volume of water in the water containing cavity (12), a water supply capable of achieving an appropriate pressure must be employed. In one example, water of an appropriate pressure is supplied using a pump, compressed air, or a similar equipment.

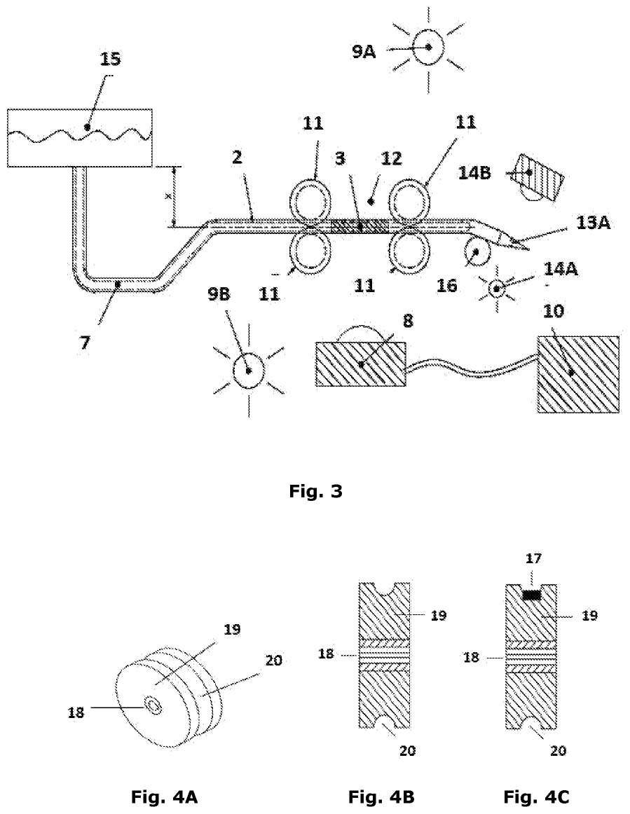

Referring to FIG. 3, in another example, the partly hollow feeding mandrel (2) for use according to the disclosure has a design as shown. According to this design, the water supply originates from a water container (15), which container is raised above the level of the measuring area (3), as indicated by the sign x on FIG. 3, to obtain a suitable water pressure in the hollow part of the feeding mandrel (2), and particularly in the hollow part of the measuring area (3).

It is currently believed, that the pressure arising from elevating the water container (15) to a level of from 20 to 60 cm above the measuring area (3) is suited for operation (i.e. x in FIG. 3 represents 20-60 cm). In another example, the container is elevated to a level of from 30 to 40 cm (i.e. x=30-40 cm), and e.g. about 38 cm. Stated differently, this set-up amounts to a water pressure in the range of from about 0.01 to about 0.05 bar, e.g. of from about 0.02 to about 0.04 bar, or around 0.03 bar.

Within this disclosure, it is also contemplated that the shape of feeding mandrel (2) should be designed to allow for gravity to facilitate loading and unloading (removal) of the intestine. According to this design, the feeding mandrel (2) has a front-end for receiving the intestine (4), which front-end of the mandrel is bend in an angle β, and a back-end, for accumulation of the loaded intestine (4), which back-end of the mandrel is bend in an angle α.

It is currently believed, that the angle α of the back-end of the mandrel should be in the interval of from 0 to about 60°, e.g. of from about 20 to about 60°, or from about 30 to about 50°, or around 45°.

It is also currently believed, that the angle β of the front-end of the mandrel should be in the interval of from 0 to about 45°, e.g. of from about 10 to about 30°, or around 20°.

In a further example, the system of the disclosure further comprises an assisting transporting device (16), capable of effectively transporting the intestine (4), and (re-)directing it to the tip of the feeding mandrel (2), and past the sensing device (14), after the intestine has been subjected to measuring at the measuring area (3). This assisting transporting device (16) may be a wheel activated and operated by the processor (10).

The vision device (8) for use according to the disclosure may include one or more commercially available cameras, e.g. an area scan camera available from Basler, having a frame rate of 100 frames/s. This camera is triggered to take pictures by blinking light, that may e.g. blink with 100 Hz.

The camera/vision system is initiated when the driving wheel is in the working position, and water is led into the intestine (4) surrounding the feeding mandrel (2). Preferably the driving wheel (11) is stopped just before the rear end of the intestine (4) reaches the at driving wheel (11), as the sensor system (14), established by the light source (14A) and the sensor (14B), detects when the intestine has been fully loaded, and the is no more intestine left.

The camera/vision system may be in operation both when the intestine (4) is loaded onto the feeding mandrel (2) and transported towards the back-end of the feeding mandrel, as well as when the intestine (4) is off-loaded, i.e. is being transported from the back-end to the front-end of the feeding mandrel.

The transporting wheels (11) may be operated by a servo motor, and distance and speed of movement of the intestine may be determined based on the number of rotations/revolutions of the servo motor. Ideally, the transporting wheels (11) moves the intestine rapidly along the feeding mandrel, both while loading the intestine (4) and off-loading/measuring the intestine at the measuring area (3). Upon detection of a hole or a point of transition, the speed may be reduced, and the hole or a point of transition on the intestine is led to the end of the feeding mandrel (2), where cutting of the intestine (4) is accomplished by the cutting device (21).

Still referring to FIG. 3, in another example, the system comprises an assisting transporting device (16), capable of effectively directing the intestine (4) to the tip of the feeding mandrel (2), and past the sensing device (14), after the intestine has been subjected to measuring at the measuring area (3).

The system may include communication-wise connection between:

a. processor (10) and camera (8);

b. processor (10) and lights (9a, 9b);

c. processor (10) and driving wheel(s) (11);

d. processor (10) and cutting device (21); and/or

e. processor (10) and assisting transporting wheel (16).

### The Transporter

In another aspect, the disclosure provides a transporter (11), engaged by one or more servo motors, in communication with, and controlled and operated by the processor (10), and having a dual activity, i.e. being:

i. capable of moving, in both directions, an intestine (4) along a feeding mandrel (2) (i.e. transporting action); and

ii. capable of building a water containing cavity (12) created by the surrounding intestine (4) (i.e. pinching/seclusion action).

In one example, each wheel (11) is engaged by a servo motor.

In another example, one servo motor engages two wheels (11) simultaneously.

The servo motor may cause the speed of the wheels to increase or decrease, as needed/desired, and in communication with, and controlled and operated by the processor (10).

In a further example, the transporter is in the form of four or more wheels (11), all made from elastomer. Such a simple design helps securing an effective cleaning of the device.

In a yet further example, the transporter is in the form of four or more wheels (11), all made from elastomer, each wheel holding a track/profile (20) in its periphery, in which profile a band made from silicon/rubber material is applied (17) to secure a more firm grip on the intestine (4). In one example, this silicon/rubber band (17) on its outwards side has a profile holding a pattern, that may secure an even better grip on the intestine (4).

In an even further example, the transporter is in the form of four or more wheels (11), each wheel being a composite wheel having a metal hub (18), and a wheel core/an outer part (19) made of elastomer, in which wheel core/outer part the periphery is shaped in a form having a profile (track) allowing close contact to the feeding mandrel (2), so that the transporter is capable of building a water containing cavity (12) created by the surrounding intestine (4).

In another example, each wheel (11) has a hub (18) made of metal.

The wheel core/outer part shall be made of elastomer to secure a firm grip when handling/transporting the intestine/casing along the feeding mandrel. In one example, the periphery of the wheel for use according to the disclosure wheel is made from silicon elastomer. The silicon elastomer for use according to the disclosure may be of a grade of from 30-80° Shore, e.g. of from 35-60° Shore, or of from 35-45° Shore.

The wheel core/outer part the periphery preferably is shaped in a form having a profile (track) (20) allowing close contact to the feeding mandrel (2), so that the transporting device (11) is capable of building a water containing cavity (12) created by the surrounding intestine (4).

The track profile (20) surrounding the periphery of the wheel may in addition be designed with a pattern to increase the grip on the intestine/casing, e.g. with a pattern resembling the thread on a car tire, or a ribbon of another material and pattern, may be immersed in the profile to provide a better grip on the intestine/casing.

### Length and Speed Measurements

In another aspect, the disclosure provides a method for automatically determining the length of an intestine (4), or parts hereof, loaded onto a feeding mandrel (2). The method may include:

providing a vision device (8), in communication with a transporting device (11), for taking multiple pictures of the intestine (4) while being transported back and forth the feeding mandrel (2);

providing a transporting device (11) in communication with the vision device (8), for transporting the intestine (4) along the feeding mandrel (2);

identification of features/patterns on the surface of the intestine (4) in a first picture;

in the next picture, calculating the number of pixels that the specific pattern identified above has moved, and determining the time elapsed since last picture taken,

calculating the distance, and hence the speed, by which the intestine has moved along the feeding mandrel; and

moving the intestine (4) so the point of interest (hole or point of transition) is brought in position for being cut.

The intestine (4) may be cut by the cutting device (21) of the disclosure.

Measuring the length of an intestine (4) loaded onto the feeding mandrel (2), and later subjected to calibration, may be accomplished using pattern recognition and digital image processing, and particularly feature extraction. Pattern recognition is a branch of machine learning that focuses on the recognition of patterns and regularities in data, in this case data obtained from the vision device (8). Feature extraction starts from an initial set of measured data, here images obtained by the camera comprised by the vision device (8). For a picture taken by the camera, a pattern of features is identified, and for each new picture taken by the camera, the pattern, or part of the pattern of features is recovered, and by calculating the number of pixels that the specific pattern has moved, and the time elapsed since last picture taken, the distance (converted from pixels to e.g. mm) and speed is calculated.

Several data analysis software packages provide for feature extraction. Common numerical programming environments such as MATLAB, SciLab, NumPy, and “the R language” provide some of the simpler feature extraction techniques via built-in commands. More specific algorithms are publicly available as scripts or third-party add-ons. There are also software packages targeting specific software machine learning applications that specialize in feature extraction.

The transporting wheels (11) may be operated by a servo motor, and distance and speed of movement of the intestine may be determined based on the number of rotations/revolutions of the servo motor. Ideally, the transporting wheels (11) moves the intestine rapidly along the feeding mandrel, both while loading the intestine (4) and off-loading/measuring the intestine at the measuring area (3). Upon detection of a hole or a point of transition, the speed may be reduced, and the hole or a point of transition on the intestine is led to the end of the feeding mandrel (2), where cutting of the intestine (4) is accomplished by the cutting device (21).

FIGS. 4A, 4B and 4C illustrate one example of a transporting wheel (11) for use with the systems illustrated in FIGS. 1-3. The transporting wheel (11) may include an optionally profiled silicon/rubber band (17), a wheel hub (18), a wheel core (19); and a track (20) or profile in the periphery of the wheel;

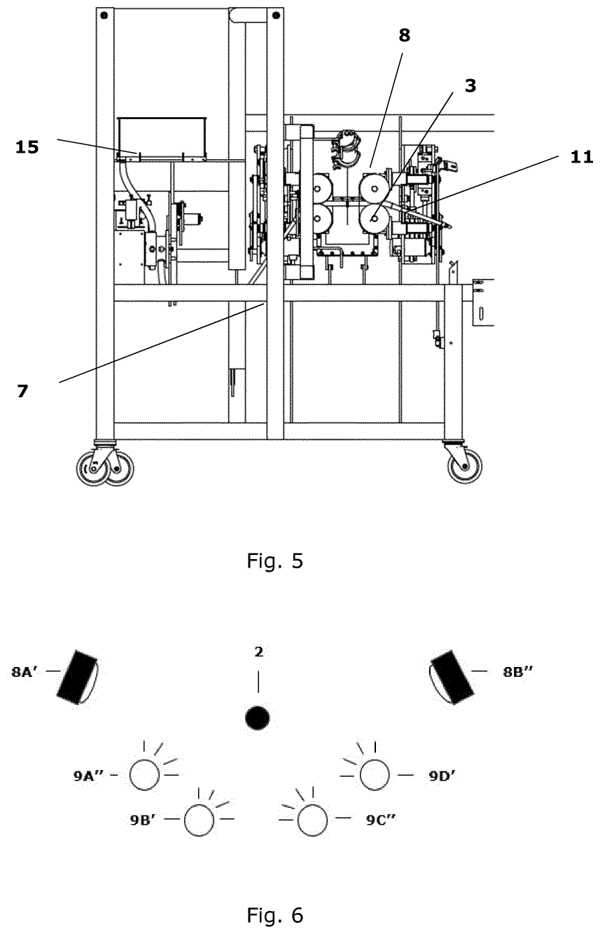

FIG. 5 is a side view diagram of a machine stand including a system for automatic calibrating, cutting and grading natural intestines as described in FIG. 1 or FIG. 2, including the measuring area (3), the water supply (7), the vision device (8), the transporter (11), and the water container (15).

FIG. 6 is a schematic illustration of a light and camera setting for use in a system for automatic calibrating, cutting and grading natural intestines as described in FIG. 1 or FIG. 2. A longitudinal view of the feeding mandrel (2) is shown. Two cameras (8A′ and 8B″) point towards the measuring area (3) of the feeding mandrel (2) from different angles. Light sources (9A″, 9B′, 9C″ and 9D′) illuminate the measuring area (3) from different angles. FIG. 6 further illustrates the use of light sources of two different colours, e.g. blue (represented by the single ′ character in 9B′ 9D′) and white (represented by the double ″ character in 9A″, 9C″), and also shows the interconnection between lights (9) and cameras (8), camera 8A′ being guided by the blue light emitted from 9B′, and the white light emitted from and 9D′, and camera 8B″ being guided by the white light emitted from 9A″, and the white light emitted from and 9C″.

A Method for Semi-Automatic or Automatic Calibrating and Grading and/or Cutting Natural Intestines

In another aspect, the disclosure relates to a method for semi-automatic or automatic gauging, calibrating, grading and/or cutting natural intestines, using the system described herein. The method may include:

a) feeding a natural intestine (4) onto the feeding mandrel (2), while water is being supplied (7) through the hollow part (5) of the feeding mandrel (2);

b) obtaining at least one image of said intestine (4), after said intestine has been feed onto said feeding mandrel (2), and has been transported past the measuring are (3), where a cavity (12) occurs as a result of the pressure of the water supply (7);

c) analysing said image obtained in Step b, using one or more lights sources (9A, 9B), and the processor (10), to determine a transition point of the intestine (4), which transition point represents a change, according to specifications, of the calibre or grade of the intestine (4), or part hereof, and/or any amendments of calibre or grade of said intestine, according to specifications, and/or to detect any perforations, according to specifications, in said intestine; and

d) transporting the intestine (4) to the tip of the feeding mandrel (2), past the sensing device (14), until a transition point, as detected according to Step c, reaches the tip of the feeding mandrel (2), where after the intestine (4) may then be cut manually, or automatically by the cutting device (21).

The intestines (4) may eventually be sorted according to size and/or quality.

The cutting device (21) for use according to the disclosure may be manually or automatically operated.

In one example, the intestine is cut manually, using a knife or scissor (21).

In another example, the intestine is cut using an automatically operated a knife or scissor (21), or by applying a laser source, capable of producing a laser light to cause the intestine to be cut.

According to Step a, the intestine (4) may be fed manually onto the feeding mandrel (2), assisted by the transporting device (11), capable of pulling the intestine on to the feeding mandrel (2). After loading, the intestine is folded up on the feeding mandrel and is ready to return past the measuring area (3).

In a further example, the transporting device (11) for use according to the disclosure is capable of transporting the intestine (4) along the feeding mandrel (1) at different speeds, and the pace may e.g. be adjusted up for a fast feeding of the intestine (4) onto the feeding mandrel (3), or it may be lowered, e.g. when the vision device (8) has detected a leak in the intestine (4), and the system proceeds to bringing the leak into position at the tip of the feeding mandrel (3) for being cut by the cutting device (21).

The method may include one or more of the following steps:

1. an operator takes an intestine (4), e.g. from a bundle of intestines;

2. the operator opens one end of the intestine, and the intestine end is located onto the end of a feeding mandrel (2);

3. the end of the intestine (4) is pulled to a position where a transporting wheel (11) can get into contact with, and grip the intestine;

4. the driving wheel (11) is positioned onto the feeding mandrel (2) with the intestine (4) end part between the feeding mandrel (2) and the driving wheel(s) (11);

5. water (7) is passed into the hollow part (5) of the feeding mandrel (2) and out of perforations (6) in the measuring area (3) of feeding mandrel (2), hereby filling the part of the intestine (4) mounted onto the feeding mandrel (2) with water, which creates a cavity and widens the intestine (4) to determine its calibre (diameter);

6. a vision system (8) is initiated, which obtains images of the intestine (4);

7. the driving wheel(s) (11) is/are started, and pull(s) the intestine (4) onto the feeding mandrel (2);

8. the speed of the wheels (11) is increased or decreased, as needed/desired, controlled by the processor (10);

9. when the rear end of the intestine is close to the driving wheel(s) (11), but has not passed the driving wheel(s), the speed of the driving wheel(s) (11) may be adjusted (decreased), and eventually the driving wheel(s) (11) is/are stopped, and the vision system (8) may stop obtaining images of the intestine (4);

10. the intestine is now fully on the feeding mandrel (2), e.g. in a compressed condition, and the processor (10) has determined the length of the intestine (4), and determined the calibre of different parts of the intestine, as well as the presence and location of any holes or lacerations;

11. the vision system (8) starts again obtaining images of the intestine (4);

12. the driving wheel(s) (11) is/are started turning the opposite direction as when the intestine was pulled onto the feeding mandrel (2);

13. the rear end of the intestine, when the intestine was pulled onto the feeding mandrel (2), will now be the front end;

14. the intestine (4) is cut by a cutting device (21) at the location with the distance between the ends of the feeding mandrel and receiving mandrel;

15. the intestine on the receiving mandrel is removed e.g. manually and positioned in a system making it possible to collect a bundle of intestine with similar calibre;

16. the ends of the feeding mandrel and receiving mandrel is pushed towards each other again; and/or

17. the end of the remaining intestine is pulled onto the first part of the receiving mandrel and the pulling and cutting process is repeated until the rear end of the intestine.

The system for use according to the present disclosure may be applied to natural intestines of animal origin, and particularly to intestines originating from domesticated animals such as pigs, cows, cattle, sheep, goats, and deer.

Small intestines, often desalted, are typically sold in bundles of 25, and may come in various calibres (i.e. diameter), e.g. in the interval of from below 25 mm to greater than 50 mm, particularly of from below 28 mm to greater than 46 mm, and in lengths of in the interval of from below 2 m to longer than 22 m.

Pig intestines, e.g. are typically graded into products of a diameter of −/26 mm, 26/28 mm, 29/30 mm, 31/32 mm, 33/34 mm, 35/36 mm, 37/38 mm and 40/+mm.

The previously desalted natural intestine is usually soaked in clean water of about 29° C.±5° C.

What is claimed is:

1. A system, for semi-automatic or automatic gauging, calibrating, grading, and cutting natural intestines or casings, the system comprising:
a partly hollow feeding mandrel configured to hold an intestine fed onto said feeding mandrel such that said intestine surrounds said feeding mandrel, wherein the feeding mandrel comprises a measuring area configured to transport water through a the hollow part of the feeding mandrel, through punctures in a surface of the measuring area, and into a cavity of the surrounding intestine, wherein the partly hollow feeding mandrel is connected to a water supply;
a vision device configured to obtain at least one image of said intestine while the intestine is being fed onto said feeding mandrel;
one or more lights sources configured to illuminate said intestine while the intestine is on said feeding mandrel;
a processor configured to process said image obtained by said vision device to determine a pattern of the intestine, to calculate a length of at least a portion of the intestine, and to determine a calibre of at least the portion of the intestine, and to detect any perforations in said intestine;
a transporting device configured to move, in multiple directions, said intestine along said feeding mandrel while simultaneously building the cavity created by the surrounding intestine; and
a sensing device configured to determine an end of said intestine and in communication with the transporting device such that the transporting device stops transporting the intestine before the end of said intestine has reached the measuring area.

2. The system according to claim 1, wherein the sensing device comprises a light source configured to project light through a hole through a tip of the feeding mandrel such that the light hits a light sensor when there is no intestine surrounding the feeding mandrel.

3. The system according to claim 1, further comprising a cutting device configured to cut the intestine at a specific location identified by the processor as a transition point, at which transition point a calibre or grade of the intestine changes according to a specification, or which transition point marks a beginning of a stretch in the intestine containing one or more holes.

4. The system according to claim 3, wherein the cutting device comprises one or more of a knife, a scissor, or a laser cutter, wherein the cutting device is automatically operated by the vision device in communication with the processor and in cooperation with the transporting device.

5. The system according to claim 1, wherein the water supply originates from a water container raised above a level of the measuring area such that water pressure is provided in the hollow part of the measuring area.

6. The system according to claim 1, further comprising an assisting transporting device configured to direct the intestine to a tip of the feeding mandrel and past the sensing device after subjecting the intestine to measuring at the measuring area.

7. A transporting device configured to move an intestine along a feeding mandrel, the transporting device comprising:
four or more wheels, wherein each wheel is a composite wheel having a metal core; and
a periphery made of elastomer, wherein the periphery is shaped in a form having a profile configured to contact a feeding mandrel such that the transporting device is configured to perform a pinching action or a seclusion action to build a water containing cavity created by intestine surrounding the feeding mandrel;
wherein the transporting device is configured to move the intestine in multiple directions along the feeding mandrel.

8. A method for automatically determining a length of at least a portion of an intestine loaded onto a feeding mandrel, comprising:
transporting the intestine back and forth on the feeding mandrel using a transporting device;
using a vision device to take a plurality of pictures of the intestine while transporting the intestine back and forth on the feeding mandrel;
identifying a pattern on the surface of the intestine in a first picture of the plurality of pictures of the intestine;
calculating a number of pixels that the identified pattern has moved between the first picture and a second picture of the plurality of pictures of the intestine;
determining an amount of elapsed time between the first picture and the second picture;
calculating a distance by which the intestine has moved along the feeding mandrel based on the calculated number of pixels and the elapsed time between the first picture and the second picture; and
moving the intestine such that a point of interest in the intestine is brought into a cutting position based at least in part on the calculated distance.

9. A method for semi-automatic or automatic gauging, calibrating, grading and cutting natural intestines comprising:
feeding a natural intestine onto a feeding mandrel while water is being supplied through a hollow part of the feeding mandrel;
obtaining at least one image of said intestine after said intestine has been feed onto said feeding mandrel and has been transported past a measuring area of the feeding mandrel, where a cavity occurs within the intestine as a result of a pressure of the water supply;
analysing said at least one image using one or more light sources a processor to determine a transition point of the intestine, which transition point represents a change in a calibre or grade of the intestine according to a specification or an amendment to the calibre or grade of the intestine according to the specification, and to detect any perforations, according to the specification in said intestine; and
transporting the intestine to a tip of the feeding mandrel, past a sensing device, until the determined transition point reaches the tip of the feeding mandrel; and
cutting the intestine using a cutting device in accordance with the transporting.
